(19) United States
(12) Patent Application Publication
(10) Pub. No.: US 2018/0267862 A1
(43) Pub. Date: Sep. 20, 2018

(54) SYSTEM AND METHOD FOR DATA CLASSIFICATION DURING FILE BACKUP

(71) Applicant: Acronis International GmbH, Schaffhausen (CH)

(72) Inventors: Eugene Aseev, Moscow (RU); Stanislav S. Protasov, Moscow (RU); Serguei M. Beloussov, Costa Del Sol (SG); Sanjeev Solanki, Pasir Ris (SG)

(21) Appl. No.: 15/922,365

(22) Filed: Mar. 15, 2018

Related U.S. Application Data
(60) Provisional application No. 62/471,429, filed on Mar. 15, 2017.

(51) Int. Cl. G06F 11/14; G06F 17/30; G06F 3/06

(52) U.S. Cl. CPC G06F 11/1451; G06F 11/1464; G06F 3/0643; G06F 17/30073

(57) ABSTRACT

A system and method is provided for data classification to control file backup operations. An exemplary method includes analyzing electronic data to identify properties and parameters of the electronic data and comparing the properties and parameters with predetermined rules that indicate storage levels based on properties and parameters. Furthermore, the method includes identifying one of the storage levels based on the comparison of the properties and parameters of the electronic data with the plurality of rules, and performing a data backup of the electronic data based on the identified storage level.

### CROSS-REFERENCE TO RELATED APPLICATIONS

The application claims priority to U.S. Provisional Patent Application No. 62/471,429 entitled “System and Method for Data Classification During File Backup” which was filed on Mar. 15, 2017, the contents of which is incorporated herein by reference in its entirety.

### TECHNICAL FIELD

The present disclosure generally relates to the field of electronic data storage, and more particularly, to a system and method for data classification to control file backup operations.

### BACKGROUND

Continuing advances in storage technology provide significant amounts of digital data to be stored cheaply and efficiently. Nevertheless, when backing up data, computer systems, administrators, and the like, are often faced with the problem of data prioritization since the amount of user data for backup is continuing to grow, which is making data backup too expensive for many businesses and individuals.

However, faced with this problem, it is also well known that portions of the user data are more critical than others portions. Thus, there is a need for a more reliable storage that provides a greater guarantee for the preservation of the more critical data. In a typical situation, the user (or the backup administrator) can set a storage priorities of various data. However, for significant volumes of data typical for modern businesses, it is not the most effective way to solve the problem.

Accordingly, a system and method is needed that provides an automated way to solve the problem of data backup for high volumes of data based on a smart data classification methodology.

### SUMMARY

Thus, a system and method is disclosed herein for data classification to control file backup operations. According to an exemplary aspect, a method is provided for performing automatic backup of electronic data. In this aspect, the method includes analyzing the electronic data to identify at least one property of the electronic data; comparing the at least one property with a plurality of rules that indicate a plurality of storage levels based on a plurality of file properties, respectively; identifying one of the plurality of storage levels based on the comparison of the at least one property of the electronic data with the plurality of rules; and performing a data backup of the electronic data based on the identified one storage level.

According to another aspect of the method, when at least one of the plurality of rules indicates that if the electronic data is shared between multiple users or multiple electronic devices, the electronic data does not require backup.

According to another aspect of the method, when at least one of the plurality of rules indicates that if the electronic data is identified as critical based on the identified at least one property of the electronic data, the electronic data is stored in a repository having maximum redundancy and safety.

According to another aspect of the method, when at least one of the plurality of rules indicates that if the electronic data is identified as not critical based on the identified at least one property of the electronic data, the electronic data is stored in only one of a storage server and a cloud storage system.

According to another aspect, the method includes providing an interface for a user to configure the plurality of rules that indicates the plurality of storage levels based on the plurality of file properties.

According to another aspect of the method, the plurality of file properties includes at least one of a file name of the electronic data, metadata of the electronic data, file content the electronic data, data access rights of the electronic data, and data access frequency the electronic data.

According to another aspect, a system is provided for performing automatic backup of electronic data. In this aspect, the system includes electronic memory configured to store a plurality of rules that indicate a plurality of storage levels based on a plurality of file properties, respectively; and a processor configured to analyze the electronic data to identify at least one property of the electronic data; compare the at least one property with the plurality of rules that indicate the plurality of storage levels based on the plurality of file properties, respectively; identify one of the plurality of storage levels based on the comparison of the at least one property of the electronic data with the plurality of rules; and perform a data backup of the electronic data based on the identified one storage level.

According to another exemplary aspect of the system, when at least one of the plurality of rules indicates that if the electronic data is shared between multiple users or multiple electronic devices, the processor determines that the electronic data does not require backup.

According to another exemplary aspect of the system, when at least one of the plurality of rules indicates that if the electronic data is identified as critical based on the identified at least one property of the electronic data, the processor causes the electronic data to be stored in a repository having maximum redundancy and safety.

According to another exemplary aspect of the system, when at least one of the plurality of rules indicates that if the electronic data is identified as not critical based on the identified at least one property of the electronic data, the processor causes the electronic data to be stored in only one of a storage server and a cloud storage system.

According to another exemplary aspect of the system, the processor is further configured to provide an interface for a user to configure the plurality of rules that indicate the plurality of storage levels based on the plurality of file properties.

According to another exemplary aspect of the system, the plurality of file properties includes at least one of a file name of the electronic data, metadata of the electronic data, file content the electronic data, data access rights of the electronic data, and data access frequency the electronic data.

The above simplified summary of example aspects serves to provide a basic understanding of the disclosure. This summary is not an extensive overview of all contemplated aspects, and is intended to neither identify key or critical elements of all aspects nor delineate the scope of any or all aspects of the disclosure. Its sole purpose is to present one or more aspects in a simplified form as a prelude to the more detailed description of the detailed description that follows. To the accomplishment of the foregoing, the one or more aspects of the disclosure include the features described and particularly pointed out in the claims.

### BRIEF DESCRIPTION OF THE DRAWINGS

The accompanying drawings, which are incorporated into and constitute a part of this specification, illustrate one or more example aspects of the disclosure and, together with the detailed description, serve to explain their principles and implementations.

FIG. 1 illustrates a block diagram of a system for data classification to control file backup operations according to an exemplary aspect.

FIG. 2 illustrates a block diagram of the data storage management device for data classification to control file backup operations according to an exemplary aspect.

FIGS. 3A and 3B illustrate a flowchart of a method for data classification to control file backup operations according to an exemplary aspect.

FIG. 4 illustrates a block diagram of an example of a general-purpose computer system on which the disclosed system and method can be implemented according to an example aspect.

### DETAILED DESCRIPTION

Various aspects are now described with reference to the drawings, wherein like reference numerals are used to refer to like elements throughout. In the following description, for purposes of explanation, numerous specific details are set forth in order to promote a thorough understanding of one or more aspects. It may be evident in some or all instances, however, that any aspect described below can be practiced without adopting the specific design details described below. In other instances, well-known structures and devices are shown in block diagram form in order to facilitate the description of one or more aspects. The following presents a simplified summary of one or more aspects in order to provide a basic understanding of the aspects. This summary is not an extensive overview of all contemplated aspects, and is not intended to identify key or critical elements of all aspects nor delineate the scope of any or all aspects.

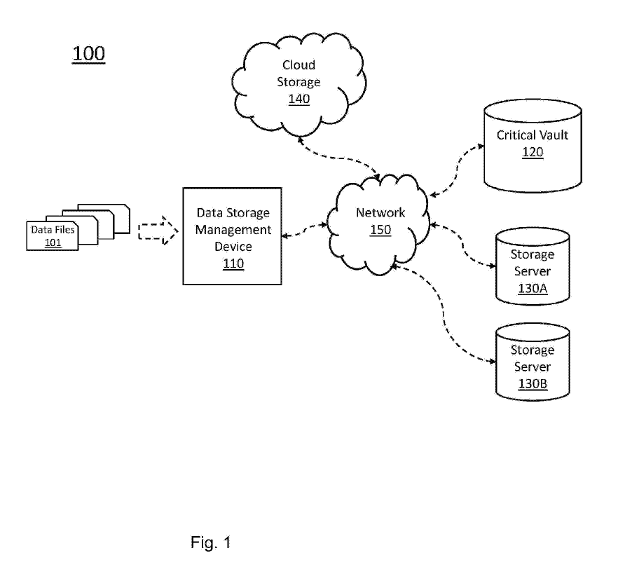

FIG. 1 illustrates a block diagram of a system for data classification to control file backup operations according to an exemplary aspect. As generally shown, the system 100 includes a data storage management device 110 that is configured to receive a plurality of data objects, data files, and other electronic and user data and control the storage of each file to one or a plurality of storage devices. In some aspects, a file is an object which resides on a file system, whereas an object can exist inside or outside of a filesystem.

According to the exemplary aspect, the storage devices can include, for example, one or more critical vaults 120, storage servers 130A and 130B, and cloud storage 140. The critical vault 120 can be a secure data device/network that provides a repository having maximum redundancy and enhanced safety/security requirements for storage as compared to other storage options. In one aspect, the critical vault 120 is data storage that stores the most recent changes of the most important files that are backed up, for example by continuous data protection, or the like. The critical data vault 120 contains primarily data that is critical in nature, not in terms of security.

In an exemplary aspect, the cloud storage 140 can be a cloud-based storage service, such as Amazon® Simple Storage Service (“S3”), and Microsoft® Azure (“Azure”). In general, companies such as Microsoft® and Amazon® (i.e., “storage service providers”) set up networks and infrastructure to provide one or more multi-client services (such as various types of cloud-based storage) that are accessible via the Internet and/or other networks to a distributed set of clients in a company, organization or the like. These storage service providers can include numerous data centers that can be distributed across many geographical locations and that host various resource pools, such as collections of physical and/or virtualized storage devices, computer servers, networking equipment and the like, needed to implement, configure and distribute the infrastructure and services offered by the storage service provider.

The storage servers 130A and 130B can be local storage servers (managed by the user, business, etc.) that provide common data backup, but not to the degree of security and safety as the critical vault 120, for example. In some aspects the storage servers 130A and 130B are on the same local or wide area network as the data storage management device 110, while in other aspects the storage servers 130A and 130B are on a different network than the data storage management device 110. In some aspects, the storage server 130A and 130B may both be on the same network, or on different networks from each other.

As further shown in FIG. 1, the data storage management device 110 is configured to communicate with each of the storage devices by one or more networks 150. According to an exemplary aspect, the applicable network 150 can be any network for communicating data and data operations and can include a communication system (not shown) that connects the various components of the system 100 by wire, cable, fiber optic, and/or wireless links facilitated by various types of well-known network elements, such as hubs, switches, routers, and the like. It should be appreciated that the network may employ various well-known protocols to communicate information amongst the network resources. In one aspect, the network can be part of the Internet or intranet using various communications infrastructure such as Ethernet, WiFi and the like.

According to the exemplary aspect, the data storage management device 110 may be configured to receive the data files 101 (in response to a request from a client device hosting the data files 101, for example) and classify the received data files accordingly. Based on the classification, the data storage management device 110 may be configured to automatically determine whether each data file needs to be stored and the type of storage level that should be afforded the data file, i.e., which of the one or more data storage devices/networks should store the data file.

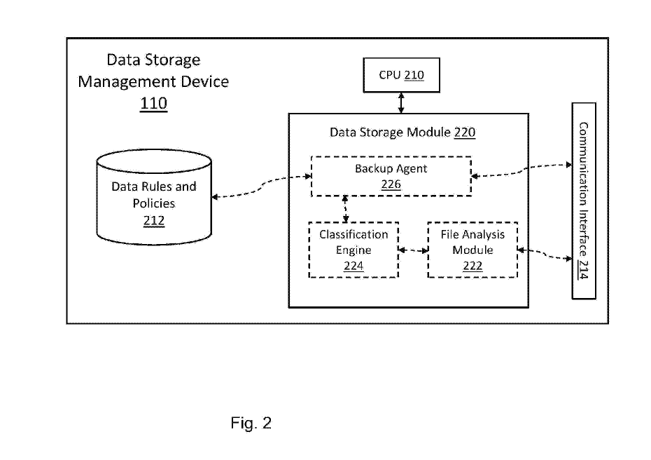

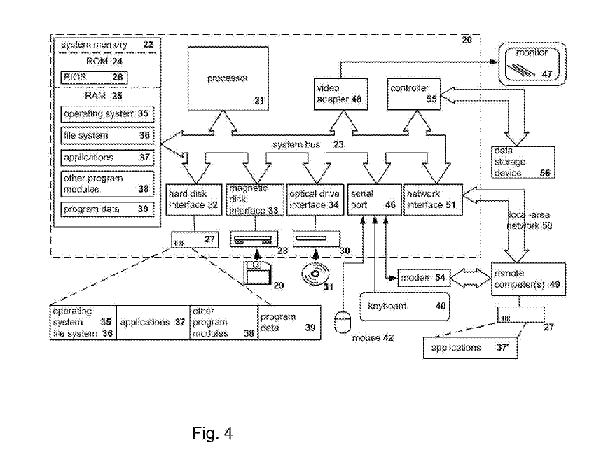

FIG. 2 illustrates a block diagram of the data storage management device for data classification to control file backup operations according to an exemplary aspect. In the exemplary aspect, the data storage management device 110 includes a central processing unit (“CPU”) 210 configured to execute one or more modules, including data storage module 220. The data storage management device 110 may be implemented on computer system shown in FIG. 4. Accordingly, although not shown in detail in FIG. 2, the data storage management device 110 also includes electronic memory that stores executable code that is executed by the CPU 210 to execute one or a plurality of modules configured to perform the algorithms disclosed herein, including the data storage module 220.

In general, the term “module” as used herein can refer to a software service or application executed on one or more computers, including real-world devices, components, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer. Accordingly, each module can be realized in a variety of suitable configurations, and should not be limited to any example implementation described herein.

As further shown, the data storage management device 110 can include a communication interface 214 (e.g., a plurality of I/O interfaces) that provides for communication with client devices requesting storage of files 101 as well as the plurality of storage devices. A more detailed example of the hardware and software components of the data storage management device 110 is discussed below with respect to FIG. 4.

Furthermore, the data storage management device 110 includes the data storage module 220 and a database of data rules and policies 212 that is accessed by the data storage module 220 to facilitate the classification of data files 101 based on identified parameters for the received data files 101. In one aspect, policies are predefined, while data rules may be dynamically created.

According to the exemplary aspect, a file analysis module 222 is a component of the data storage module 220 and is configured to analyze/parse the received files 101 to extract and collect file properties and parameters (where properties and parameters are used interchangeably throughout the disclosure). According to one aspect, the file properties and parameters may include the metadata of the received files 101.

This file analysis module is coupled to the classification engine 224, which receives the collected metadata. The classification engine 224 is configured to classify each file according to certain parameters and properties of the file 101. In some aspects, the parameters and properties used by the classification engine 224 may include: file extension (i.e., file type), such as .doc, .pdf, .jpeg and the like; data type, which is a broader parameter compared to file type parameter and includes both the file types and other criteria that allow classification of the data to one or another categories; file name (e.g., if the file name contains any words or phrases that identify its level of importance, such as “Important”, “Confidential”, “Passwords”, “Contract”, and the like); file metadata (e.g., keywords); file content; data access rights (e.g., security policy applied to the file); and data access frequency (how often/rare was a file opened/read, etc.). It should be appreciated that while these particular properties are identified for purposes of the exemplary aspect, additional file properties and/or parameters can be used for classification of the file according to alternative aspects.

Upon identifying one or a plurality of the properties and parameters of the data files 101, the classification engine 224 provides the classification to the backup agent 226, which can also be a component of the data storage module 220, according to an exemplary aspect. In this regard, the backup agent 226 is configured to access the data rules and policies 212, which can be stored in the memory of data storage management device 110, and apply the properties/parameters to the set of rules to automatically determine the required backup level for the particular data objects/files 101 depending on the classification. In one example, the data rules and policies 212 may be a number of business rules formed of “If/Then” statements. Thus, applying each of the parameters and properties as the “If” statement, the resulting action (i.e., the “Then” statement) will define the appropriate storage level (i.e., storage procedure or instruction) for storage/archive of each of the files 101, as discussed in more detail below.

For example, in one aspect, the classification engine 224 can determine whether the file 101 is used for sharing, i.e., it is shared file between multiple devices and/or users. The usage determination can be based on one or more of the file metadata, data access frequency and/or data access rights, for example. In a refinement of this aspect, the classification engine 224 can also use the identified parameters to determine whether a file of the files 101 is stored in “synchronized directories”, as for example, it is stored using known synchronization cloud services such as Dropbox®, Microsoft® OneDrive® or Google Drive®. Based on the classifications by the classification engine 224, there may be a data rule and policy that indicates that the file of files 101 may be excluded from the files for backup because the probability of loss is significantly lower. Accordingly, the backup agent 226 is configured to apply the identified properties to the data rules and policies 212 and confirm that no backup is needed for this particular file. In this instance, the data storage module 220 will take no further action and will not send the file to one of the storage systems discussed above.

In yet another example, the classification engine 224 can identify each of the files 101 (alternatively referred to as a singular file 101) as important or critical based on the file name, file owner, or the like. In this instance, the data rules and policies 212 may include a rule that if the data file 101 is recognized as important or critical, then during the backup process, a repository can be selected that enables increased guarantee of protection (e.g., preservation and safety of the file). For example, the file 101 may be stored with higher redundancy (e.g., in both storage servers 130A and 130B, compared with conventional data (i.e., not critical data) that may be stored in a single storage server. In one aspect, critical data is that data which is of at least a certain level of importance to a user. Changes to critical files can make a difference to the user. In a refinement of this aspect, the data file 101 that is critical or important may be simultaneously stored in the cloud storage 140 and also in one or more local storage servers 130A and 130B. In yet another refinement, such critical data 101 may be stored in critical vault 120, which can be a data repository having maximum redundancy and enhanced safety requirements for storage, according to the exemplary aspect.

Furthermore, the data rules and policies 212 can include rules indicating that conventional (e.g., ordinary, or non-critical) data, which does not represent the increased importance or criticality value, can be stored in accordance with the standard terms and conditions (policies) backup, such as being stored in only one local storage server 130A or 130B. Finally, in accordance with the established rules of the classification, some of the data can be recognized as unimportant and not requiring any type of backup.

Accordingly, it should be appreciated that according to the exemplary system 100, the data storage management device 110 provides an automated data storage process that automatically classifies each data file 101 based on identified properties and parameters and stores the files according to different storage protocols providing varying levels of security and safety. Moreover, the storage rules can be predefined in accordance with data rules and policies 212, which may be configurable and predefined by a system administrator, operator, or the like. For example, the data storage module 220 may include a software module configured to generate a graphical user interface (“GUI”) that can be presented on a screen of the data storage management device 110. The GUI may provide a series of business rules in one aspect, If/Then statements) that can be configurable by a user of the device 110 (i.e., a system administrator) to set the storage rules accordingly. For example, if the system 100 is being implemented by a company, the rules may include the option to identify all files created/modified by one or more particular users (e.g., each officer of the business) as “critical”. Moreover, the files created/modified by other uses will be treated as “ordinary” or “normal” files, unless other parameters and properties apply. Based on the classifications of the classification engine 224, the files can be stored according to the data backup rules (e.g., “critical” files are stored in critical vault 120) as described above.

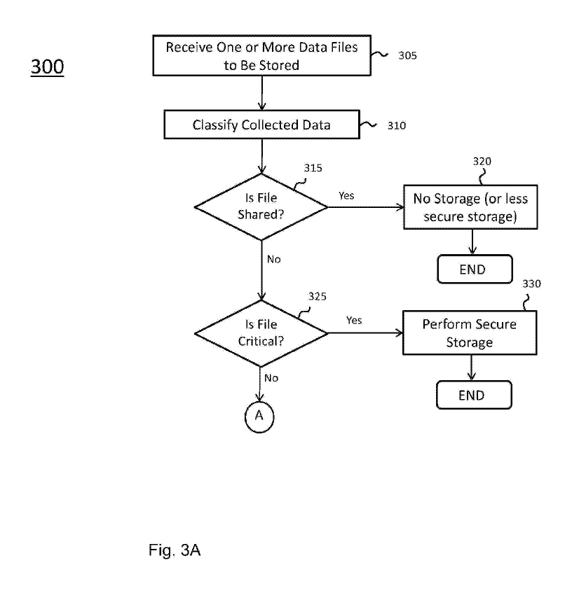

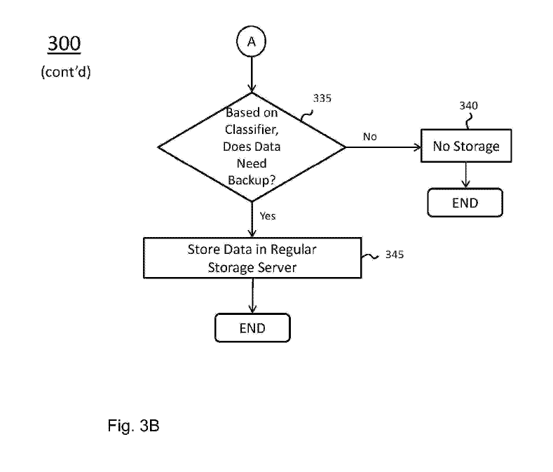

FIGS. 3A and 3B illustrate a flowchart of a method 300 for data classification to control file backup operations according to an exemplary aspect. The method 300 is an exemplary implementation of components of the system 100 as executed by portions of the computer 20 shown in FIG. 4.

Initially, at step 305, the data storage management device 110 receives one or more data files or objects (e.g., data files 101) to be archived. As noted above, the files may be transmitted by a client device requesting archive or in response to a periodic archive procedure performed by the data storage management device 110 for each client device it is managing, for example. Next, at step 310, each file 101 is passed to file analysis module 222 where the file parameters and properties are identified and passed to classification engine 224 of data storage module 220 to classify each file according to the identified parameters and properties.

The classification of each file 101 is then passed to backup agent 226. According to an exemplary aspect, at step 315, the backup agent 226 determines whether the file has been classified by classification engine 224 as a “shared” file (shared between multiple users) as discussed above. Moreover, if the file is classified as “shared”, there may be data backup rules in the data rules and policies 212 that indicate that “shared files do not need to be stored and only need to be archived in a local storage server 130A, for example. Thus, at step 320, the backup agent 226 applies the “shared” classification to the data rules and policies 212 and performs the defined archive procedure. For example, if the “shared” file is to be stored on a local storage server, the backup agent 226 may identify the appropriate storage server and transmit the file to this server for storage accordingly.

Alternatively, if the file is not deemed “shared”, the process proceeds to step 325 and determines whether the file is classified as important, or, “critical” according to classification engine 224, as discussed above. If so, the method proceeds to step 330 where the backup agent 226 performs the secure storage procedure, such as transmitting this critical file to critical vault 120 according to an exemplary aspect.

Otherwise, the method proceeds to step 335 as shown in FIG. 3B. At this step, the backup agent 226 applies the identified parameters and properties to the data rules and policies 212 to determine whether the file requires any archiving. If not, the method proceeds to step 340 where no backup is performed and the method ends. In one example, the file can be deleted from the local memory of the data storage management device 110. Otherwise, if the file 101 requires regular archive/backup, the backup agent 226 causes the file 101 to be transmitted to one of storage servers 130A or 130B, or cloud storage 140, for example. Again, these storage procedures are defined in the data rules and policies 212, and can be set in advance by a system administrator for example. In view of this method, an automatic storage algorithm is provided for classifying and storing files accordingly.

FIG. 4 illustrates a block diagram of an example of a general-purpose computer system (which can be a server) on which the disclosed system and method can be implemented according to an example aspect. As shown, a general purpose computing device is provided in the form of a computer system 20 or the like including a processing unit 21, a system memory 22, and a system bus 23 that couples various system components including the system memory to the processing unit 21. It should be appreciated that computer system 20 can correspond to the data storage management device 110, processing unit 21 can correspond to CPU 210, and system memory 22 and/or file system 36 can correspond to memory configured to store the data rules and policies 212 and/or code for executing data storage module 220.

As further shown, the system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system 26 (BIOS), containing the basic routines that help transfer information between elements within the computer 20, such as during start-up, is stored in ROM 24.

The computer 20 may further include a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD-ROM, DVD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer-readable instructions, data structures, program modules and other data for the computer 20.

Although the exemplary environment described herein employs a hard disk, a removable magnetic disk 29 and a removable optical disk 31, it should be appreciated by those skilled in the art that other types of computer-readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules (e.g., data storage module 220) may be stored on the hard disk, magnetic disk 29, optical disk 31, ROM 24 or RAM 25, including an operating system 35. The computer 20 includes a file system 36 associated with or included within the operating system 35, one or more application programs 37, other program modules 38 and program data 39. A user may enter commands and information into the computer 20 through input devices such as a keyboard 40 and pointing device 42. Other input devices (not shown) may include a microphone, joystick, game pad, satellite dish, scanner or the like.

These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers.

The computer 20 may operate in a networked environment using logical connections to one or more remote computers 49. The remote computer (or computers) 49 may be another computer, a server, a router, a network PC, a peer device or other common network node, and typically includes many or all of the elements described above relative to the computer 20. The logical connections include a network interface 51 and connected to a local area network (i.e., LAN) 51, for example, and/or a wide area network (not shown). Such networking environments are commonplace in offices, enterprise-wide computer networks, Intranets and the Internet. It should be appreciated that remote computers 49 can correspond to the different storage systems described above and/or client computers having the files 101 to be archived.

When used in a LAN networking environment, the computer 20 is connected to the local network 51 through a network interface or adapter 53. When used in a WAN networking environment, the computer 20 typically includes a modem 54 or other means for establishing communications over the wide area network, such as the Internet.

The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for performing automatic backup of electronic data, the method comprising:
analyzing electronic data to identify at least one property of the electronic data;
determining whether the electronic data will be archived by comparing the at least one property with a plurality of rules that indicate a plurality of storage levels based on a plurality of file properties, respectively;
identifying one of the plurality of storage levels based on the comparison of the at least one property of the electronic data with the plurality of rules; and
performing a data backup of the electronic data according to the identified one storage level.

2. The method according to claim 1, wherein at least one of the plurality of rules indicates that if the electronic data is shared between multiple users or multiple electronic devices, the electronic data does not require backup.

3. The method according to claim 1, wherein at least one of the plurality of rules indicates that if the electronic data is identified as critical based on the identified at least one property of the electronic data, the electronic data is stored in a repository having maximum redundancy and safety.

4. The method according to claim 3, wherein at least one of the plurality of rules indicates that if the electronic data is identified as not critical based on the identified at least one property of the electronic data, the electronic data is stored in only one of a storage server and a cloud storage system.

5. The method according to claim 1, further comprising providing an interface for a user to configure the plurality of rules that indicate the plurality of storage levels based on the plurality of file properties.

6. The method according to claim 1, wherein the plurality of file properties includes at least one of a file name of the electronic data, metadata of the electronic data, file content the electronic data, data access rights of the electronic data, and data access frequency the electronic data.

7. The method of claim 1, wherein the plurality of rules comprises business rules formed of “If/then” statements, wherein applying the at least one property correspond to the “If” statement and a resulting storage level corresponds to the “Then” statement.

8. A system for performing automatic backup of electronic data, the system comprising:
electronic memory configured to store a plurality of rules that indicate a plurality of storage levels based on a plurality of file properties, respectively; and
a processor configured to:
analyze the electronic data to identify at least one property of the electronic data;
determine whether the electronic data is archived by comparing the at least one property with the plurality of rules that indicate the plurality of storage levels based on the plurality of file properties, respectively;
identify one of the plurality of storage levels based on the comparison of the at least one property of the electronic data with the plurality of rules; and
perform a data backup of the electronic data according to the identified one storage level.

9. The system according to claim 8, wherein at least one of the plurality of rules indicates that if the electronic data is shared between multiple users or multiple electronic devices, the processor determines that the electronic data does not require backup.

10. The system according to claim 8, wherein at least one of the plurality of rules indicates that if the electronic data is identified as critical based on the identified at least one property of the electronic data, the processor causes the electronic data to be stored in a repository having maximum redundancy and safety.

11. The system according to claim 10, wherein at least one of the plurality of rules indicate that if the electronic data is identified as not critical based on the identified at least one property of the electronic data, the processor causes the electronic data to be stored in only one of a storage server and a cloud storage system.

12. The system according to claim 8, wherein the processor is further configured to provide an interface for a user to configure the plurality of rules that indicate the plurality of storage levels based on the plurality of file properties.

13. The system according to claim 8, wherein the plurality of file properties includes at least one of a file name of the electronic data, metadata of the electronic data, file content the electronic data, data access rights of the electronic data, and data access frequency the electronic data.

14. A non-transitory computer-readable medium, storing thereon instructions that when executed by a hardware processor, perform a method for performing automatic backup of electronic data, the method comprising:
analyzing the electronic data to identify at least one property of the electronic data;
determining whether the electronic data is archived by comparing the at least one property with a plurality of rules that indicate a plurality of storage levels based on a plurality of file properties, respectively;
identifying one of the plurality of storage levels based on the comparison of the at least one property of the electronic data with the plurality of rules; and
performing a data backup of the electronic data according to the identified one storage level.

15. The medium according to claim 14, wherein at least one of the plurality of rules indicates that if the electronic data is shared between multiple users or multiple electronic devices, the electronic data does not require backup.

16. The medium according to claim 14, wherein at least one of the plurality of rules indicates that if the electronic data is identified as critical based on the identified at least one property of the electronic data, the electronic data is stored in a repository having maximum redundancy and safety.

17. The medium according to claim 16, wherein at least one of the plurality of rules indicates that if the electronic data is identified as not critical based on the identified at least one property of the electronic data, the electronic data is stored in only one of a storage server and a cloud storage system.

18. The medium according to claim 14, wherein the method further comprises providing an interface for a user to configure the plurality of rules that indicate the plurality of storage levels based on the plurality of file properties.

19. The medium according to claim 14, wherein the plurality of file properties includes at least one of a file name of the electronic data, metadata of the electronic data, file content the electronic data, data access rights of the electronic data, and data access frequency the electronic data.

20. The medium of claim 14, wherein the plurality of rules comprises business rules formed of “If/then” statements, wherein applying the one or more properties correspond to the “If” statement and a resulting storage level corresponds to the “Then” statement.
